(19) United States
(12) Patent Application Publication
(10) Pub. No.: US 2025/0071086 A1
(43) Pub. Date: Feb. 27, 2025

(54) ADDRESS RESOLUTION PROTOCOL (ARP)-PROXY UPDATE FOR ROAMING CLIENT DEVICES

(71) Applicant: Cisco Technology, Inc., San Jose, CA (US)

(72) Inventors: Pascal Thubert, Roquefort-les-Pins (FR); Jerome Henry, Pittsboro, NC (US)

(73) Assignee: Cisco Technology, Inc., San Jose, CA (US)

(21) Appl. No.: 18/813,893

(22) Filed: Aug. 23, 2024

Related U.S. Application Data
(60) Provisional application No. 63/578,284, filed on Aug. 23, 2023.

(51) Int. Cl. H04L 61/45; H04L 61/103

(52) U.S. Cl. CPC H04L 61/45; H04L 61/103

(57) ABSTRACT

Address Resolution Protocol (ARP)-proxy update for roaming client devices may be provided. A client device may query for a list of active Internet Protocol (IP) addresses used by the client device. Next, the client device may determine that an Access Point (AP) supports a collaborative IP exchange function. Then the client device may send, in response to determining that the AP supports the collaborative IP exchange function, the list of active Internet Protocol (IP) addresses to the AP.

### RELATED APPLICATION TECHNICAL FIELD

Under provisions of 35 U.S.C. § 119 (e), Applicant claims the benefit of U.S. Provisional Application No. 63/578,284 filed Aug. 23, 2023, which is incorporated herein by reference.

### TECHNICAL FIELD

The present disclosure relates generally to providing Address Resolution Protocol (ARP)-proxy update for roaming client devices.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Address Resolution Protocol (ARP)-proxy update for roaming client devices;

FIG. 2 is a flow chart of a method for providing Address Resolution Protocol (ARP)-proxy update for roaming client devices; and

FIG. 3 is a block diagram of a computing device.

### DETAILED DESCRIPTION

### Overview

Address Resolution Protocol (ARP)-proxy update for roaming client devices may be provided. A client device may query for a list of active Internet Protocol (IP) addresses used by the client device. Next, the client device may determine that an Access Point (AP) supports a collaborative IP exchange function. Then the client device may send, in response to determining that the AP supports the collaborative IP exchange function, the list of active Internet Protocol (IP) addresses to the AP.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11 standard may require an Address Resolution Protocol (ARP) proxy function in APs to limit the broadcasts. This function may only work if the AP knows all the IP addresses that a give client device (i.e., station (STA)) may host. Unfortunately, if this process works well with IPv4, with IPv6 the address allocation may be very dynamic (with Stateless Address Autoconfiguration (SLAAC)), and IPv6 Neighbor Discovery (ND) may not be observed as reliably as with Dynamic Host Configuration Protocol (DHCP). Some addresses may be missed, causing the “silent node” problem. This also means that the ARP-proxy may not be relied upon.

The following scenario may illustrate this issue. A client device (i.e., a STA) may self-assign and may use more than one IPv6 address. Then the client device may stop using one of these IPv6 addresses. The client device may then roam to a new AP. On the new AP, the client device may not immediately use that IPv6 address. From the wired network (and the APs) standpoint, the (temporarily unused) IPv6 address may still be associated to the previous AP. The network may have no knowledge of whether the IPv6 should be moved to the new AP (e.g., because it is going to be used in the future) or if it should be timed out (e.g., the address should be released). If the address has not been used by the client device on the new AP, it should not be proxied there. But any packet (e.g., keepalives) sent to that address end up dying on the old AP. This issue of “ghost” IPv6 addresses may challenge Wi-Fi networks. Accordingly there may be a need for a process where the client device may share with the ARP-proxy the addresses that it intends to keep using.

Embodiments of the disclosure may provide a process for the client device to share its IP (e.g., IPv4/IPv6) addresses with the ARP-proxy function that the AP runs and update the ARP-proxy as the addresses change, which may be frequent for IPv6 addresses. The list of active IP addresses may follow the client device as it roams, thus avoiding the issue of “ghost” addresses that were once used by a client device and are no longer used. The AP may not know if the client device plans to use them again in the future, or if these addresses should be passed to the next AP as part of the client device context.

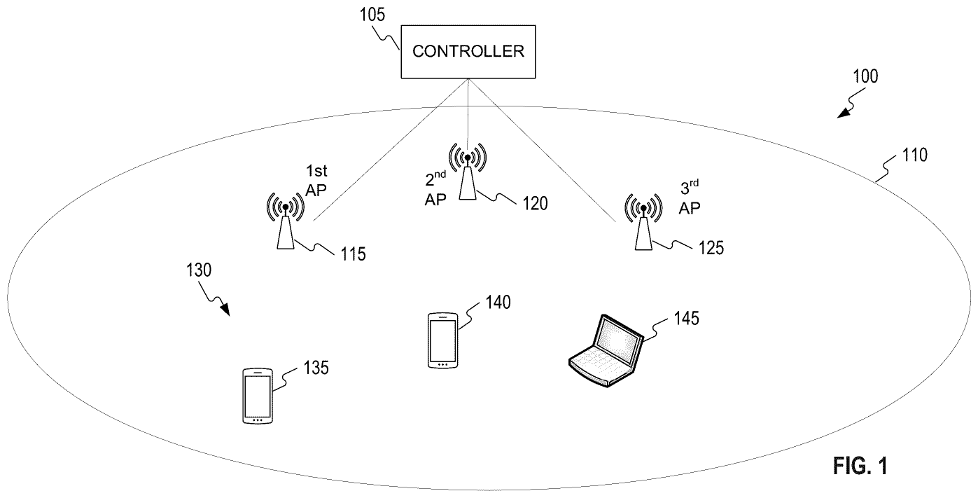

FIG. 1 shows an operating environment 100 for providing Address Resolution Protocol (ARP)-proxy update for roaming client devices. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN) for devices. The plurality of APs may comprise a first AP 115, a second AP 120, and a third AP 125. Each of the plurality of APs may be compatible with specification standards such as, but not limited to, the Institute of Electrical and Electronics Engineers (IEEE) 802.11 specification standard for example.

A plurality of devices 130 may be deployed in coverage environment 110. The plurality of APs may provide wireless network access to plurality of devices 130 as the devices move within coverage environment 110. Coverage environment 110 may comprise an outdoor or indoor wireless environment for Wi-Fi or any type of wireless protocol or standard.

Plurality of devices 130 may comprise a first client device 135, a second client device 140, and a third client device 145. Ones of plurality of devices 130 may comprise, but are not limited to, a smart phone, a personal computer, a tablet device, a mobile device, a telephone, a remote control device, a set-top box, a digital video recorder, an Internet-of-Things (IoT) device, a smart watch, a smart Television (TV), a wireless docking station, a network computer, a router, an AR/VR device, an Automated Transfer Vehicle (ATV), a drone, an Unmanned Aerial Vehicle (UAV), a smart wireless light bulb, or other similar microcomputer-based device.

Controller 105 may comprise a Wireless Local Area Network controller (WLC) and may provision and control coverage environment 110 (e.g., a WLAN). Controller 105 may allow plurality of client devices 130 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide ARP-proxy update for roaming client devices.

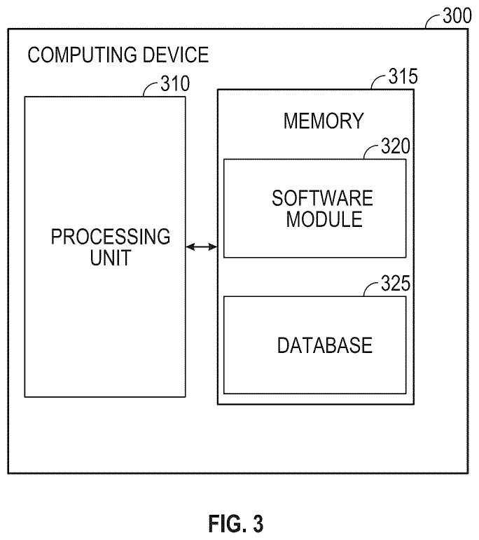

The elements described above of operating environment 100 (e.g., controller 105, first AP 115, second AP 120, third AP 125, first client device 135, second client device 140, and third client device 145) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

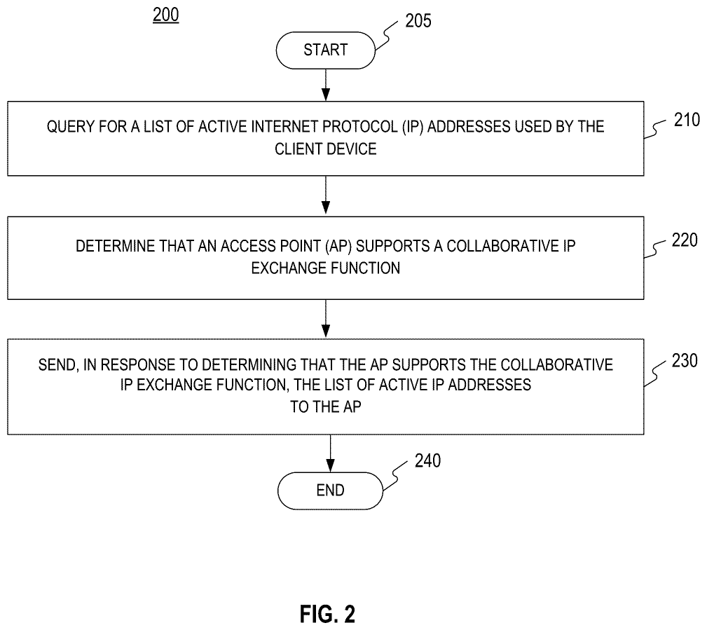

FIG. 2 is a flow chart setting forth the general stages involved in a method 200 consistent with embodiments of the disclosure for providing Address Resolution Protocol (ARP)-proxy update for roaming client devices. Method 200 may be implemented using computing device 300 as described in more detail below with respect to FIG. 3. Computing device 300 may be embodied by any of plurality of devices 130 for example. Ways to implement the stages of method 200 will be described in greater detail below.

Embodiments of the disclosure may provide a cooperative process (e.g., a collaborative IP exchange) between a client device and an AP to maintain the IPs of importance in the AP-proxy function. For example, the list of IP addresses associated to a client device may be passed at Layer-2 (L2) of the Open Systems Interconnection (OSI) model. That list may be encrypted with the L2 traffic so it may be trusted by the AP as being what the client device believes it owns.

Method 200 may begin at starting block 205 and proceed to stage 210 where first client device 135 may query for a list of active Internet Protocol (IP) addresses used by first client device 135. For example, the lower Layers (L2) in the client device may query the Operating System (OS)/upper stack for the list of all the active IPv4 and IPv6 addresses (e.g., addresses that passed Duplicate Address Detection (DAD) in the case of IPv6). This may be done, for example, with an upcall Application Programming Interface (API). In another example, this may be done by snooping Neighbor Discovery (ND) and Multicast Listener Discovery (MLD) inside the stack (e.g., as opposed to over the air where packets may be missed). This call may be possible in all OSs that may maintain a local ARP table, which may be updated dynamically (i.e., the OS may add and remove local addresses as they start/stop being used).

From stage 210, where first client device 135 queries for the list of active Internet Protocol (IP) addresses used by first client device 135, method 200 may advance to stage 220 where first client device 135 may determine that an AP (e.g., first AP 115, second AP 120, or third AP 125) supports a collaborative IP exchange function. For example, first client device 135 and the AP may exchange capability information on this collaborative IP exchange function. In one embodiment, first client device 135 may query the AP prior (or after) association through Generic Advertisement Service (GAS)/Access Network Query Protocol (ANQP). In another embodiment, a capability Information Element (IE) may be present in the pre-association/association exchanges.

Once first client device 135 determines that the AP (e.g., first AP 115, second AP 120, or third AP 125) supports the collaborative IP exchange function in stage 220, method 200 may continue to stage 230 where first client device 135 may send, in response to determining that the AP supports the collaborative IP exchange function, the list of active IP addresses to the AP. For example, once association completes, and if both sides support collaborative IP exchange, first client device 135 may send the list of its active IP addresses to the AP. In one embodiment, GAS/ANQP may be used to send the list. In another embodiment, the list may comprise a data frame preceded, for example, by an action frame signaling the start of this exchange.

Consistent with embodiments of the disclosure, at agreed upon intervals, first client device 135 may refresh the list of active IP addresses with the AP. This may be done, for example, by passing the full list at each heartbeat. In another embodiment, the list of active IP addresses may be synchronized between first client device 135 and the AP is a manner similar to routing protocols (e.g., difference since previous update, triggered update upon change, etc.)

Once received, the AP may inject the list of active IP addresses in the ARP-proxy function. Addresses that did not exist in the ARP-proxy may be installed to be proxied for. Addresses that are not in the list from first client device 135 may be removed from the ARP-proxy.

As the client devices roam, the process may repeat on the new AP. The old AP, passing the client device context to the new AP, may optionally pass the list of its proxied addresses. In all cases, the new AP may obtain from the client device the new list of addresses, and only proxies the addresses received from the client device. Optionally, the new AP may share the list of addresses with the old AP (or the WLC). Unused addresses may be flushed from the wired side of the infrastructure. After first client device 135 sends, in response to determining that the AP supports the collaborative IP exchange function, the list of active IP addresses to the AP in stage 230, method 200 may then end at stage 240.

In another embodiment, the client device may add meta information for each address. A possible meta information may comprise time since address was formed. Another meta information may comprise lifetime expectation for that address. Yet another meta information may comprise recent amount of traffic and projection for the future. A simpler embodiment of this last element is a sorted list of addresses (from most used to least used).

The meta information may be useful, because the client device may generate an unlimited number of addresses, while the client device proxy function only has a limited number of slots available to store addresses for a given client device. The AP may use these elements to arbitrate which addresses to store, if all addresses cannot be stored. In this embodiment, the proxy answers with information and status such as “limits reached” if the proxy reaches a limit of addresses per client device or per radio. The client device may then manage its own storage (e.g., by sending a refreshed list of active addresses as needed, allowing unused addresses to be removed from the proxy).

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing Address Resolution Protocol (ARP)-proxy update for roaming client devices as described above with respect to FIG. 2. Computing device 300, for example, may provide an operating environment for controller 105, first AP 115, second AP 120, third AP 125, first client device 135, second client device 140, or third client device 145. Controller 105, first AP 115, second AP 120, third AP 125, first client device 135, second client device 140, and third client device 145 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
querying, by a client device, for a list of active Internet Protocol (IP) addresses used by the client device;
determining that an Access Point (AP) supports a collaborative IP exchange function; and
sending, in response to determining that the AP supports the collaborative IP exchange function, the list of active IP addresses to the AP.

2. The method of claim 1, wherein querying for the list of active Internet Protocol (IP) addresses comprises querying an Operating System (OS) stack of the client device.

3. The method of claim 2, wherein querying the OS stack of the client device comprises using an upcall Application Programming Interface (API).

4. The method of claim 2, wherein querying the OS stack of the client device comprises snooping one of Neighbor Discovery (ND) and Multicast Listener Discovery (MLD).

5. The method of claim 1, wherein determining that the AP supports the collaborative IP exchange function comprises exchanging capability information wherein the client device queries the AP through Generic Advertisement Service (GAS)/Access Network Query Protocol (ANQP).

6. The method of claim 1, wherein determining that the AP supports the collaborative IP exchange function comprises exchanging capability information using a capability Information Element (IE) in association exchanges.

7. The method of claim 1, wherein sending the list of active Internet Protocol (IP) addresses to the AP comprises using Generic Advertisement Service (GAS)/Access Network Query Protocol (ANQP).

8. The method of claim 1, wherein sending the list of active Internet Protocol (IP) addresses to the AP comprises using a data frame.

9. The method of claim 8, wherein the data frame is preceded by an action frame signaling a start of an exchange.

10. The method of claim 1, further comprising refreshing, by the client device, the list of active IP addresses with the AP.

11. A system comprising:
a memory storage; and
a processing unit disposed in a client device and coupled to the memory storage, wherein the processing unit is operative to:
query for a list of active Internet Protocol (IP) addresses used by the client device;
determine that an Access Point (AP) supports a collaborative IP exchange function; and
send, in response to determining that the AP supports the collaborative IP exchange function, the list of IP addresses to the AP.

12. The system of claim 11, wherein the processing unit being operative to query for the list of active Internet Protocol (IP) addresses comprises the processing unit being operative to query an Operating System (OS) stack of the client device.

13. The system of claim 12, wherein the processing unit being operative to query the OS stack of the client device comprises the processing unit being operative to use an upcall Application Programming Interface (API).

14. The system of claim 12, wherein the processing unit being operative to query the OS stack of the client device comprises the processing unit being operative to snoop one of Neighbor Discovery (ND) and Multicast Listener Discovery (MLD).

15. The system of claim 11, wherein the processing unit being operative to determine that the AP supports the collaborative IP exchange function comprises the processing unit being operative to exchange capability information wherein the client device queries the AP through Generic Advertisement Service (GAS)/Access Network Query Protocol (ANQP).

16. A non-transitory computer-readable medium that stores a set of instructions which when executed perform a method executed by the set of instructions comprising:
querying, by a client device, for a list of active Internet Protocol (IP) addresses used by the client device;
determining that an Access Point (AP) supports a collaborative IP exchange function; and
sending, in response to determining that the AP supports the collaborative IP exchange function, the list of active IP addresses to the AP.

17. The non-transitory computer-readable medium of claim 16, wherein querying for the list of active Internet Protocol (IP) addresses comprises querying an Operating System (OS) stack of the client device.

18. The non-transitory computer-readable medium of claim 17, wherein querying the OS stack of the client device comprises using an upcall Application Programming Interface (API).

19. The non-transitory computer-readable medium of claim 17, wherein querying the OS stack of the client device comprises snooping one of Neighbor Discovery (ND) and Multicast Listener Discovery (MLD).

20. The non-transitory computer-readable medium of claim 16, wherein determining that the AP supports the collaborative IP exchange function comprises exchanging capability information wherein the client device queries the AP through Generic Advertisement Service (GAS)/Access Network Query Protocol (ANQP).
